(19) United States
(12) Patent Application Publication
(10) Pub. No.: US 2021/0083709 A1
(43) Pub. Date: Mar. 18, 2021

(54) SMARTPHONE HANGING BRACKET

(71) Applicant: KOODEE METAL CO.,LTD, Guangzhou (CN)

(72) Inventor: Xinquan Liu, Guangzhou (CN)

(21) Appl. No.: 16/723,294

(22) Filed: Dec. 20, 2019

Related U.S. Application Data
(60) Provisional application No. 62/900,787, filed on Sep. 16, 2019.

(51) Int. Cl. H04B 1/3877; F16B 47/00; F16M 13/02

(52) U.S. Cl. CPC H04B 1/3877; F16M 13/022; F16B 47/00

(57) ABSTRACT

A hanging bracket includes a plate body and at least one connection arm. The plate body has a first surface, a second surface opposing the first surface, a first lateral side, and a second lateral side opposing the first lateral side with respect to the first surface. The plate body further includes a plurality of hanger slots, and each of the plurality of hanger slots is separated to each other and extending from the first lateral side toward the second lateral side. The at least one connection arm, protruding from the second surface, has a connection end and an adhesion end opposing the connection end. The connection end is fixed onto the second surface of the plate body, and the adhesion end is used for anchoring the smartphone hanging bracket to an object. In particular, a thickness of the plate body is ranging from 2 to 5 mm.

### CROSS REFERENCE TO RELATED APPLICATION

This application claims the benefits of U.S. provisional application No. 62/900,787, filed on Sep. 16, 2019, the disclosures of which are incorporated by references herein in its entirety.

### TECHNICAL FIELD

The present disclosure relates in general to a convenient hanging bracket, and more particularly to a hanging bracket for detachably mounting a smartphone vertically.

### BACKGROUND

Nowadays, a smartphone, a pod or the like portable electronic device has been widely applying as one of personal all-time portable belongings. Convenience it provides is easy to see, but, in some situations, portability and/or placement of this kind of products may be bothering.

One of the existing problems is the occupation of the portable electronic device on the desktop. This situation may occur while the user neighboring to a desk is at rest or at work, and the portable electronic device at this time may be in a recharge state or in providing audio or video services. Sometimes, the portable electronic device may stand on the desktop via a hanger ring or a specific stand frame. However, such a standing structure does occupy a substantial space on the crowded desktop surface.

Another of the existing problems is to stabilize the mounting of the portable electronic devices on the desktop. Obviously, the hanger ring or the stand frame is too light to stably position the heavier electronic device on the desktop, especially on a slippery surface. Thus, a predetermined display state of the portable electronic device is usually interrupted by its own weight or unexpected forcing. Namely, the stability of standing the portable electronic device is usually not acceptable.

A further existing problem is portability of the portable electronic device while another portable object such as a bottle for containing drinking water exists. This situation may happen to the user in biking or jogging, when either the water bottle or the electronic device can be waived.

In addition, in any of the aforesaid situations, collection of the charging cable and/or the earphone/speaker wire is obvious a notorious problem.

Thus, it is definitely welcome and urgent in the art to provide a design for resolving the existing portability and placement problems upon the portable electronic device such as a smartphone.

### SUMMARY

Accordingly, an object of the present disclosure is to provide a smartphone hanging bracket for detachably mounting a smartphone or the like portable electronic device so as to alleviate the aforesaid shortcomings to some degree. In this disclosure, the hanging bracket includes a plate body and at least one connection arm. The plate body has a first surface, a second surface opposing the first surface, a first lateral side, and a second lateral side opposing the first lateral side with respect to the first surface. The plate body further includes a plurality of hanger slots, and each of the plurality of hanger slots is separated to each other and extending from the first lateral side toward the second lateral side. The at least one connection arm, protruding from the second surface, has a connection end and an adhesion end opposing the connection end. The connection end is fixed onto the second surface of the plate body, and the adhesion end is used for anchoring the smartphone hanging bracket to an object. In particular, a thickness of the plate body is ranging from 2 to 5 mm.

In one embodiment of this disclosure, the the hanger slots have different widths. Preferably, the widths of the hanger slots are arranged in an ascending order from a top-to-bottom direction of the plate body.

In one embodiment of this disclosure, the hanger slots have different lengths. Preferably, the lengths of the hanger slots are arranged in an ascending order from a top-to-bottom direction of the plate body.

In one embodiment of this disclosure, the adhesion end is formed as a suction cup.

Another object of this present disclosure is to provide a columnar structure with a smartphone hanging bracket. The columnar structure includes a first installation surface and the smartphone hanging bracket attached to the first installation surface. The hanging bracket includes a plate body and at least one connection arm. The plate body has a first surface, a second surface opposing the first surface, a first lateral side, and a second lateral side opposing the first lateral side with respect to the first surface. The plate body further includes a plurality of hanger slots, and each of the plurality of hanger slots is separated to each other and extending from the first lateral side toward the second lateral side. The at least one connection arm, protruding from the second surface to connect the front surface for maintaining a predetermined space between the plate body and the first installation surface, has a connection end and an adhesion end opposing the connection end. The connection end is fixed onto the second surface of the plate body, and the adhesion end is fixed to the first installation surface. In particular, a thickness of the plate body is ranging from 2 to 5 mm.

In one embodiment of this disclosure, the the hanger slots have different widths. Preferably, the widths of the hanger slots are arranged in an ascending order from a top-to-bottom direction of the plate body.

In one embodiment of this disclosure, the hanger slots have different lengths. Preferably, the lengths of the hanger slots are arranged in an ascending order from a top-to-bottom direction of the plate body.

In one embodiment of this disclosure, the adhesion end is formed as a suction cup.

In one embodiment of this disclosure, the columnar structure further includes a second installation surface and a pocket fixed onto the second installation surface.

In one embodiment of this disclosure, the columnar structure is a bottle, and the first installation surface is located oppositely to the second installation surface.

In one embodiment of this disclosure, the columnar structure is a column, and the first installation surface is located oppositely to the second installation surface.

As stated above, the smartphone hanging bracket provided in this disclosure includes the plate body having the hanger slots for conveniently mounting the smartphone vertically, and the connection arms for generating a slim space for collecting a cable or a speaker wire. Thereupon, the aforesaid conventional shortcomings in occupying the desktop space, stabilizing the mounting of the smartphone on the desktop and portability while existing another portable object can be substantially resolved.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of a first embodiment of the smartphone hanging bracket in accordance with this disclosure;

FIG. 2A is a schematic right-hand side view of FIG. 1;

FIG. 2B is a schematic left-hand side view of FIG. 1;

FIG. 3 is a schematic perspective view of an application of the smartphone hanging bracket of FIG. 1;

FIG. 4 is a schematic perspective view of another application of the smartphone hanging bracket of FIG. 1;

FIG. 5 is a schematic perspective view of an application of FIG. 4 that mounts a smartphone;

FIG. 6 is a schematic perspective view of an embodiment of the columnar structure with the smartphone hanging bracket of FIG. 1 in accordance with this disclosure;

FIG. 7 is a schematic view of another embodiment of the columnar structure with the smartphone hanging bracket of FIG. 1 in accordance with this disclosure;

FIG. 8 is a schematic view of a second embodiment of the smartphone hanging bracket in accordance with this disclosure; and

FIG. 9 is a schematic perspective view of a third embodiment of the smartphone hanging bracket in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

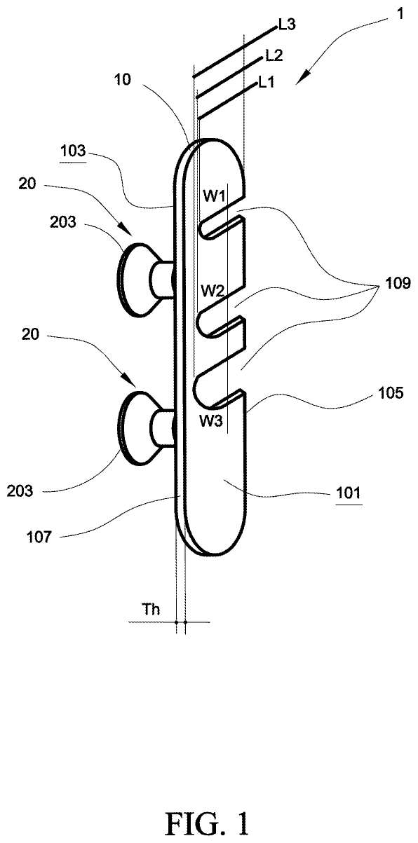

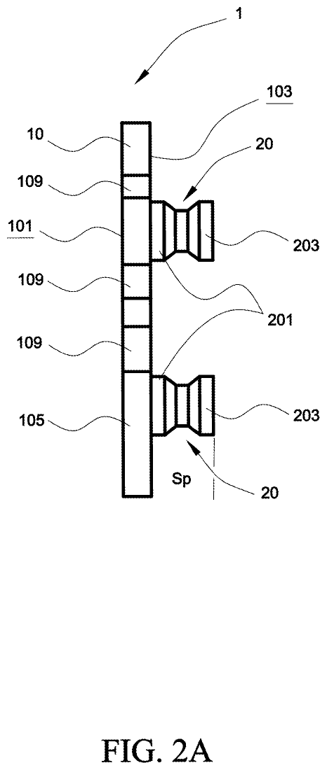

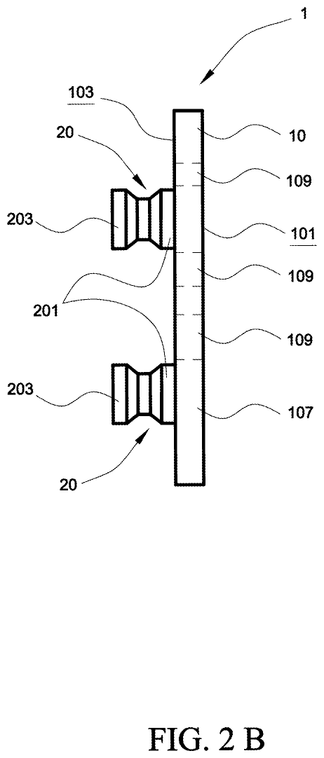

Refer now to FIG. 1 to FIG. 2B; where FIG. 1 is a schematic perspective view of a first embodiment of the smartphone hanging bracket in accordance with this disclosure, FIG. 2A is a schematic right-hand side view of FIG. 1, and FIG. 2B is a schematic left-hand side view of FIG. 1.

As shown, the hanging bracket 1 includes a plate body 10 and at least one connection arm 20 (two shown in this embodiment). The plate body 10, shaped largely as a rounded rectangular plate, has a first surface 101, a second surface 103 opposing the first surface 101, a first lateral side 105, and a second lateral side 107 opposing the first lateral side 105 with respect to the first surface 101. The plate body 10 is further furnished with a plurality of hanger slots 109 (three shown in this embodiment), and each of the hanger slots 109 is separated to each other 109 and extending from the first lateral side 105 toward the second lateral side 107. Namely, the hanger slot 109 has an open end at the first lateral side 105 an a blind end close to the second lateral side 107. The connection arm 20, protruding from the second surface 103, has a connection end 201 and an adhesion end 203 opposing the connection end 201. The connection end 201 is fixed onto the second surface 103 of the plate body 10 by a first connection means, and the adhesion end 203 is used for anchoring the smartphone hanging bracket 1 to an object (not shown herein) via a second connection means. In particular, a thickness (Th) of the plate body 10 is ranging from 2 to 5 mm. It shall be understood that the thickness (Th) of the body plate 10 is not limited to the aforesaid setting, but to the practical requirements. In this embodiment, the plate body 10 is used for mounting vertically an electronic device with a hanger ring, and thus a relevant thickness (Th) for the plate body 10 can be within 2-5 mm.

In accordance with this disclose, the first connection means can be a gluing means, a suction means, or any the like. While the first connection means is a gluing means, the connection end 201 of the connection arm 20 is fixed to the second surface 105 of the plate body 10 via a relevant glue. While the first connection means is a suction means, the connection end 201 of the connection arm 20 is formed as a suction cup to be vacuum sucked onto the second surface 105 of the plate body 10. In addition, according to this disclosure, the connection arm 20 and the plate body 10 can be manufactured as a unique piece.

In accordance with this disclose, the second connection means can be a gluing means, a suction means, or any the like. While the second connection means is a gluing means, the adhesion end 203 of the connection arm 20 can be fixed to a target surface of the object via a relevant glue. While the second connection means is a suction means, the adhesion end 203 of the connection arm 20 is formed as a suction cup to be vacuum sucked onto the target surface of the object.

In this disclosure, widths of the hanger slots 109 may be the same or different. As shown, in this embodiment, these three hanger slots 109 have different widths (W1≠W2, W2≠W3, and W1≠W3). Preferably, the widths of the hanger slots 109 are arranged in an ascending order from a top-to-bottom direction TB of the plate body 10; i.e., W1≤W2≤W3.

Further, in this disclosure, lengths of the hanger slots 109 may be the same or different. As shown, in this embodiment, these three hanger slots 109 have different lengths (L1≠L2, L2≠L3, and L1≠L3). Preferably, the lengths of the hanger slots 109 are arranged in an ascending order from the top-to-bottom direction TB of the plate body 10; i.e., L1≤L2≤L3.

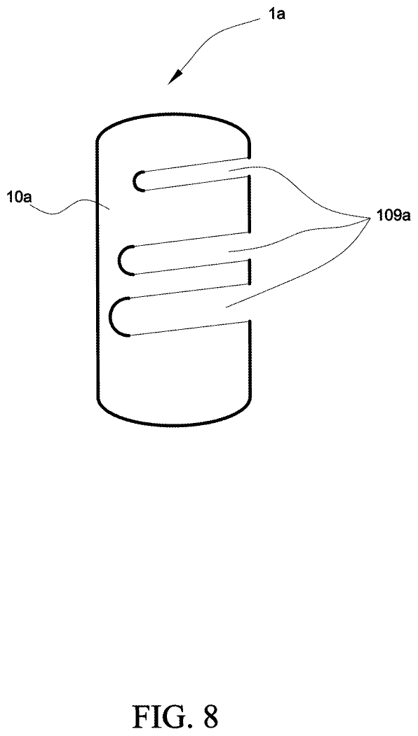

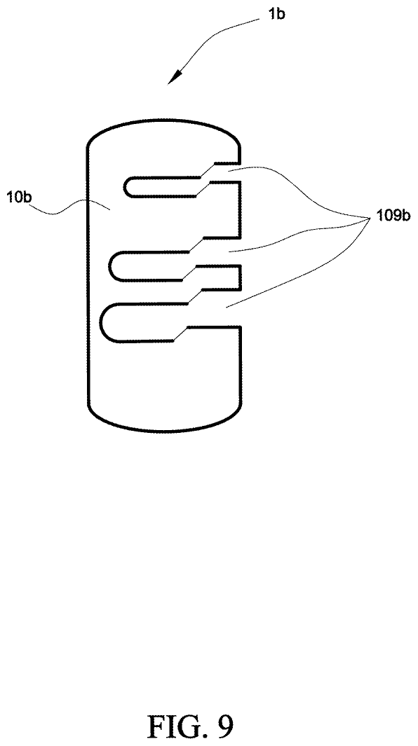

In this disclosure, extending of the hanger slots 109 is not limited to be linear as shown in FIG. 1. In other embodiments, shown exemplarily in FIG. 8 and FIG. 9, the hanger slots can be obliquely extended or even bently extended. In practice, one major requirement for shaping the hanger slot 109 is to stably engage and hold, for example, the hanger ring at the back of the portable electronic device.

In this disclosure, the smartphone hanging bracket is applied to pair a columnar structure such as a bottle and a construction column, or to be adhered onto a wall, such that the smartphone or the portable electronic device can be mounted thereon vertically through the engagement of the holder ring and one of the hanger slots 109.

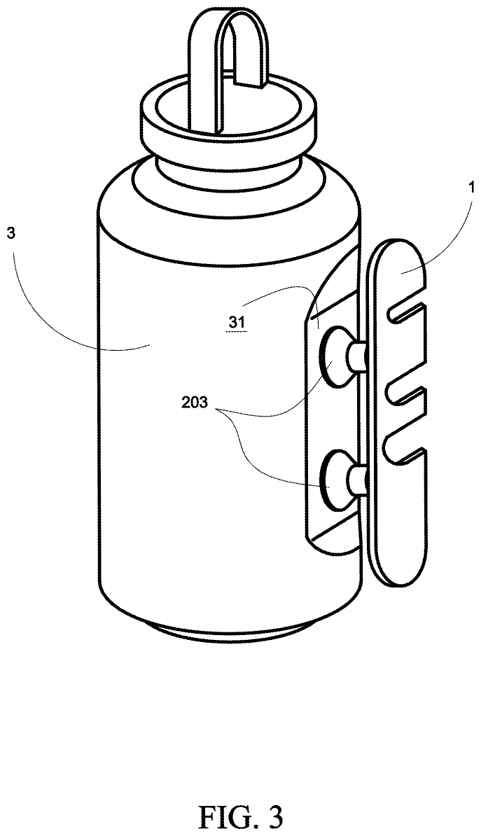

Referring to FIG. 3, a schematic perspective view of an application of the smartphone hanging bracket of FIG. 1 is shown. In this embodiment, the columnar structure, embodied as a bottle 3, includes a first installation surface 31, and the smartphone hanging bracket 1 is attached to the first installation surface 31 by having the adhesion ends 203 of the corresponding connection arms 20 fixed onto the first installation surface 31 of the bottle 3. It is shown that, while the smartphone hanging bracket 1 is mounted to the bottle 3, a space (Sp) would be formed between the first installation surface 31 and the second surface 103 of the plate body 10. In application, this space (Sp) can be used for the cable or wire (not shown herein) connected to the electronic device (not shown herein) to be collected by winding around the connection arms 20.

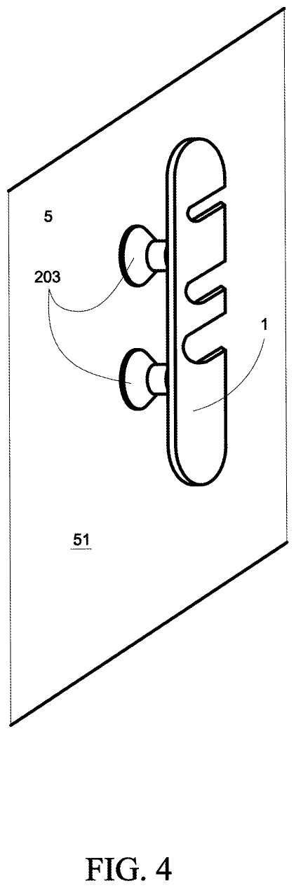

Referring to FIG. 4, a schematic perspective view of another application of the smartphone hanging bracket of FIG. 1 is shown. In this embodiment, the smartphone hanging bracket 1 is attached to another first installation surface 51 of a wall 5 by having the adhesion ends 203 of the corresponding connection arms 20 fixed onto the first installation surface 51 of the wall 5. Similarly, while the smartphone hanging bracket 1 is mounted to the wall 3, a space (Sp) is formed between the first installation surface 51 of the wall 5 and the second surface 103 of the plate body 10.

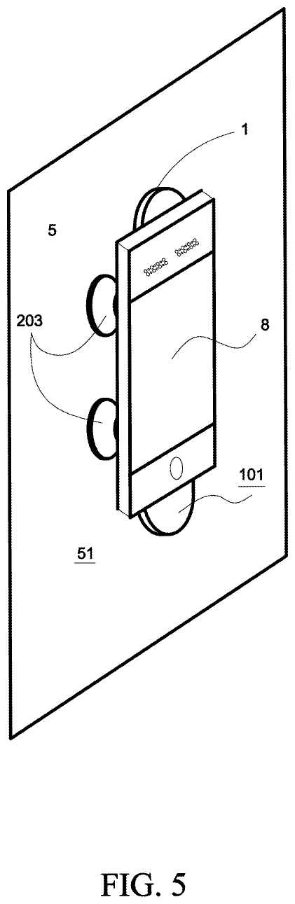

Referring to FIG. 5, a smartphone 8 is mounted vertically to the wall 5 through the smartphone hanging bracket 1, via the hanger ring (not shown herein) at the back of the smartphone phone to engage (by penetrating and bending down) one of the hanger slots 109. With the space (Sp) provided between the first installation surface 51 of the wall 5 and the second surface 103 of the plate body 10, the charging cable or the speaker wire (not shown herein) connected to the electronic device (not shown herein) can be collected by winding around the connection arms 20.

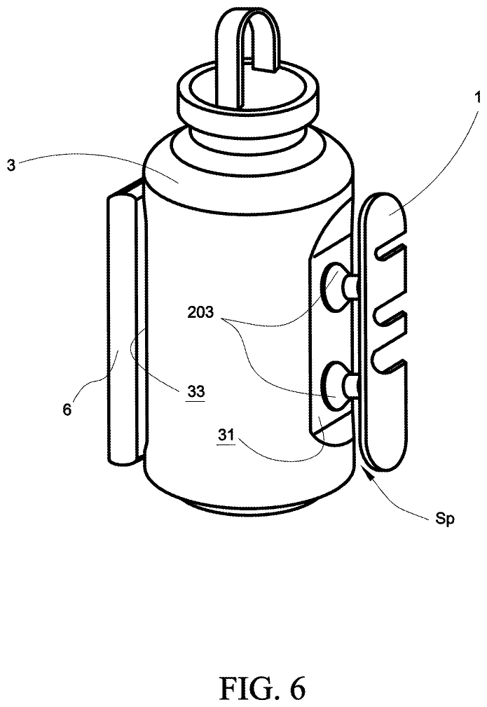

Referring to FIG. 6, a schematic perspective view of an embodiment of the columnar structure with the smartphone hanging bracket of FIG. 1 in accordance with this disclosure. Actually, this embodiment demonstrates an improvement of FIG. 3.

Besides all the elements of FIG. 3, this bottle 3 further includes a second installation surface 33 located oppositely to the first installation surface 31. An optional pocket 6 for containing cables, sires, cards, coins, power banks or the like is provided by being adhered to the second installation surface 33. In this disclosure, the pocket 6 can be a zipper-type bag or a bag with a foldable cover lip, and can be fixed to the second installation surface 33 via gluing or a magic-tape means.

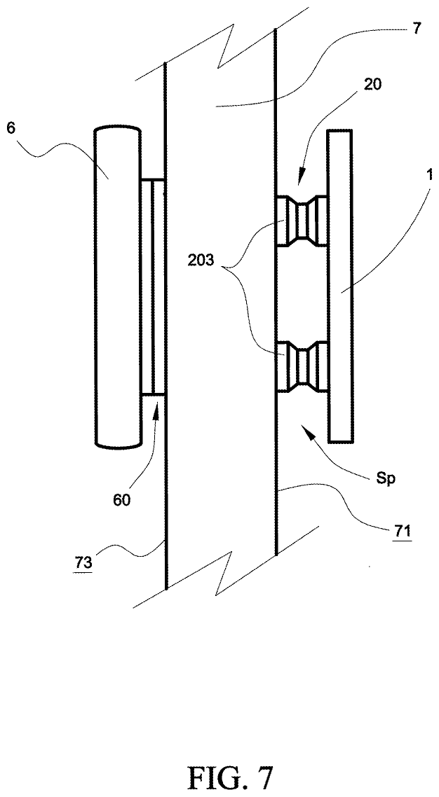

Referring to FIG. 7, a schematic view of another embodiment of the columnar structure with the smartphone hanging bracket of FIG. 1 in accordance with this disclosure. In this embodiment, the columnar structure is embodied as a column 7 having a second installation surface 71 and a second installation surface 73 opposing the first installation surface 71. The smartphone hanging bracket 1 is fixed to the first installation surface 71 of the column 7, while the pocket 6 is fixed onto the second installation surface 73 via a magic-tape means 60.

In this disclosure, a material for producing the smartphone hanging bracket 1 can be metallic or non-metallic (plastics for example).

As described above, the smartphone hanging bracket provided in this disclosure includes the plate body having the hanger slots for conveniently mounting the smartphone vertically, and the connection arms for generating a slim space for collecting a cable or a speaker wire. Thereupon, the aforesaid conventional shortcomings in occupying the desktop space, stabilizing the mounting of the smartphone on the desktop and portability while existing another portable object can be substantially resolved.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A smartphone hanging bracket, comprising:
a plate body, having a first surface, a second surface opposing the first surface, a lateral side, and a second lateral side opposing the first lateral side with respect to the first surface, further including a plurality of hanger slots, each of the plurality of hanger slots being separated to each other and extending from the first lateral side toward the second lateral side; and
at least one connection arm, protruding from the second surface, having a connection end and an adhesion end opposing the connection end, the connection end being fixed onto the second surface, the adhesion end being used for anchoring the smartphone hanging bracket an object;
wherein a thickness of the plate body is ranging from 2 to 5 mm.

2. The smartphone hanging bracket of claim 1, wherein the hanger slots have different widths.

3. The smartphone hanging bracket of claim 1, wherein widths of the hanger slots are arranged in an ascending order from a top-to-bottom direction of the plate body.

4. The smartphone hanging bracket of claim 1, wherein the hanger slots have different lengths.

5. The smartphone hanging bracket of claim 1, wherein lengths of the hanger slots are arranged in an ascending order from a top-to-bottom direction of the plate body.

6. The smartphone hanging bracket of claim 1, wherein the adhesion end is formed as a suction cup.

7. A columnar structure with a smartphone hanging bracket, comprising:
a first installation surface, disposed on the columnar structure; and
the smartphone hanging bracket, attached to the first installation surface, including:
a plate body, having a first surface, a second surface opposing the first surface, a lateral side, and a second lateral side opposing the first lateral side with respect to the first surface, further including a plurality of hanger slots, each of the plurality of hanger slots being separated to each other and extending from the first lateral side toward the second lateral side; and
at least one connection arm, protruding from the second surface to connect the front surface for maintaining a predetermined space between the plate body and the first installation surface, having a connection end and an adhesion end opposing the connection end, the connection end being fixed onto the second surface, the adhesion end being fixed to the first installation surface.

8. The columnar structure with a smartphone hanging bracket of claim 7, wherein the hanger slots have different widths.

9. The columnar structure with a smartphone hanging bracket of claim 7, wherein widths of the hanger slots are arranged in an ascending order from a top-to-bottom direction of the plate body.

10. The columnar structure with a smartphone hanging bracket of claim 7, wherein the hanger slots have different lengths.

11. The columnar structure with a smartphone hanging bracket of claim 7, wherein lengths of the hanger slots are arranged in an ascending order from a top-to-bottom direction of the plate body.

12. The columnar structure with a smartphone hanging bracket of claim 7, wherein the adhesion end is formed as a suction cup.

13. The columnar structure with a smartphone hanging bracket of claim 7, wherein the columnar structure further includes a second installation surface and a pocket fixed onto the second installation surface.

14. The columnar structure with a smartphone hanging bracket of claim 7, wherein the columnar structure is a bottle, and the first installation surface is located oppositely to the second installation surface.

15. The columnar structure with a smartphone hanging bracket of claim 7, wherein the columnar structure is a column, and the first installation surface is located oppositely to the second installation surface.
